(19) United States
(12) Patent Application Publication
(10) Pub. No.: US 2002/0146542 A1
(43) Pub. Date: Oct. 10, 2002

(54) Porous polyethylene film with an ink jet printed surface

(76) Inventors: Pang-Chia Lu, Pittsford, NY (US); Benoit Ambroise, Fairport, NY (US); Jeffrey J. O'Brien, Walworth, NY (US); Bruce C. Campbell, Rochester, NY (US); Mark J. Smith, Rochester, NY (US)

Correspondence Address: ExxonMobil Chemical Company, P.O. Box 2149, Baytown, TX, 77522, US

(21) Appl. No.: 09/778,558

(22) Filed: Feb. 7, 2001

(51) Int. Cl. B41M 5/00

(52) U.S. Cl. 428/195

(57) ABSTRACT

A film with an ink jet printed surface is provided. The film is biaxially stretched and includes a surface layer of high density polyethylene (HDPE) and particles of an incompatible material. This surface layer has a meshed network of HDPE fibers and striations of layers coplanar with the plane of the film. This surface layer is porous in a direction perpendicular to the plane of the film and has a void content of at least about 20%. The surface layer is provided with a coating of a porous ink receiving layer.

### BACKGROUND

A film with an ink jet printed surface is provided.

In a typical ink jet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent in order to prevent clogging of the nozzle. The solvent, or carrier liquid, typically is made up of water, an organic material such as a monohydric alcohol, a polyhydric alcohol or mixtures thereof.

An ink jet recording element typically comprises a support having on at least one surface thereof an ink-receiving or image-forming layer, and includes those intended for reflection viewing, which have an opaque support, and those intended for viewing by transmitted light, which have a transparent support.

While a wide variety of different types of image-recording elements for use with ink jet devices have been proposed heretofore, there are many unsolved problems in the art and many deficiencies in the known products which have limited their commercial usefulness.

It is well known that in order to achieve and maintain photographic-quality images on such an image-recording element, an ink jet recording element must:

Be readily wetted so there is no puddling, i.e., coalescence of adjacent ink dots, which leads to non-uniform density.

Exhibit no image bleeding.

Exhibit the ability to absorb high concentrations of ink and dry quickly to avoid elements blocking together when stacked against subsequent prints or other surfaces.

Exhibit no discontinuities or defects due to interactions between the support and/or layer(s), such as cracking, repellencies, comb lines and the like.

Not allow unabsorbed dyes to aggregate at the free surface causing dye crystallization, which results in bloom or bronzing effects in the imaged areas.

Have an optimized image fastness to avoid fade from contact with water or radiation by daylight, tungsten light, or fluorescent light.

An ink jet recording element that simultaneously provides an almost instantaneous ink dry time and good image quality is desirable. However, given the wide range of ink compositions and ink volumes that a recording element needs to accommodate, these requirements of ink jet recording media are difficult to achieve simultaneously.

In ink jet printing operations it is an advantage to provide a microporous material substrate that accepts a wide variety of ink jet printing inks, including organic solvent-based inks which are incompatible with water, organic solvent-based inks which are compatible with water, and water-based inks.

Another advantage is very rapid drying of most inks to the tack-free stage upon ink jet printing the microporous material substrates. This advantage is quite important in high speed runs and in multicolor printing.

A further advantage is the sharpness of the printed image that can be attained. This is especially important in graphic arts applications where fine lines, detailed drawings, or halftone images are to be printed. Halftone images printed on the microporous material substrate ordinarily exhibit high degrees of dot resolution.

Ink jet printing, especially when a water-based ink jet printing ink is used, is particularly suitable for printing bar codes on microporous material substrates. The resulting bars are sharp and of high resolution, which are important factors in reducing errors when the codes are read by conventional methods and equipment. The ink dries very rapidly when applied, thereby minimizing loss of bar resolution due to smearing in subsequent handling operations.

It may be necessary to wash and dry a microporous material substrate, after being printed with water-based printing ink, using a conventional household washer and a conventional household drier. It is an advantage that upon completion of the washing and drying operations that the printed colors hold fast with no significant fading.

The above-mentioned advantages are discussed in U.S. Pat. No. 4,861,644. In this patent it is stated that these advantages are achieved with a microporous material substrate comprising (1) a matrix consisting essentially of linear ultrahigh molecular weight polyolefin, (2) a large proportion of finely divided water-insoluble siliceous filler, and (3) interconnecting pores.

As pointed out in U.S. Pat. No. 4,861,644, inasmuch as ultrahigh molecular weight (UHMW) polyolefin is not a thermoset polymer having an infinite molecular weight, it is technically classified as a thermoplastic. However, because the molecules are essentially very long chains, UHMW polyolefin, and especially UHMW polyethylene, softens when heated but does not flow as a molten liquid in a normal thermoplastic manner. In U.S. Pat. No. 4,861,644, it is stated that the very long chains and the peculiar properties they provide to UHMW polyolefin are believed to contribute in large measure to the desirable properties of the microporous material substrate.

In view of the flow characteristics of UHMW polyethylene, it is difficult to process into the form of a film. As described in U.S. Pat. No. 4,861,644, a processing plasticizer is blended with UHMW polyethylene and precipitated silica to improve film forming characteristics. Examples of such processing plasticizers include processing oil such as paraffinic oil, naphthenic oil, or aromatic oil. After the film is formed the processing plasticizer is removed by an extraction step.

A particular process for forming the film of U.S. Pat. No. 4,861,644 involves mixing filler, thermoplastic organic polymer powder, processing plasticizer and minor amounts of lubricant and antioxidant until a substantially uniform mixture is obtained. The weight ratio of filler to polymer powder employed in forming the mixture is essentially the same as that of the microporous material substrate to be produced. The mixture, together with additional processing plasticizer, is introduced to the heated barrel of a screw extruder. Attached to the extruder is a sheeting die. A continuous sheet formed by the die is forwarded without drawing to a pair of heated calender rolls acting cooperatively to form continuous sheet of lesser thickness than the continuous sheet exiting from the die. The continuous sheet from the calender then passes to a first extraction zone where the processing plasticizer is substantially removed by extraction with an organic liquid which is a good solvent for the processing plasticizer, a poor solvent for the organic polymer, and more volatile than the processing plasticizer. Usually, but not necessarily, both the processing plasticizer and the organic extraction liquid are substantially immiscible with water. The continuous sheet then passes to a second extraction zone where the residual organic extraction liquid is substantially removed by steam and/or water. The continuous sheet is then passed through a forced air dryer for substantial removal of residual water and remaining residual organic extraction liquid. From the dryer the continuous sheet, which is microporous material substrate, is passed to a take-up roll.

The microporous substrate described in U.S. Pat. No. 4,861,644, or a substrate similar thereto, is believed to be commercially available from PPG Industries, Inc., under the tradename Teslin®. The porous nature of this image-recording element allows inks to penetrate the surface of the element to produce text and/or graphic images. However, the cost of producing these elements is relatively high. In addition, the image density has been found to be low and the physical stiffness of the element is below what would be desired in an inkjet receiver sheet. U.S. Pat. No. 5,605,750 has already addressed the shortcomings of image density via application of an upper image-forming ink receiving layer. Thus, it can be seen that a need still exists in the art for the provision of an opaque image-recording element suitable for use in an inkjet printer, which is capable of recording images having fast dry times and good optical densities but which is capable of being manufactured at a relatively low manufacturing cost.

### SUMMARY

There is provided a film comprising an ink jet printed microporous material comprising (a) an extruded film layer and (b) a coating layer coated on a surface of said extruded film layer (a), wherein said extruded film layer is biaxially stretched and porous, wherein said extruded film layer (a) comprises high density polyethylene (HDPE) and particles of an incompatible material, wherein said extruded film layer (a) has a meshed network of HDPE fibers and striations of layers coplanar with the plane of the film, wherein said extruded film layer (a) is porous in a direction perpendicular to the plane of the film, wherein said extruded film layer (a) has a void content of at least about 20%, and wherein said coating layer (b) is a porous ink receiving layer with interconnecting voids.

The ink jet printing ink may be present on at least a portion of the ink receiving substance of coating (b) in the form of indicia, one or more patterns, one or more designs, or a combination thereof.

There is also provided a method for producing an ink jet printed microporous material, said method comprising applying ink jet printing ink from an ink jet printer upon at least one surface of a coated microporous material, wherein said coated microporous material comprises (a) an extruded film layer and (b) a coating layer coated on a surface of said extruded film layer (a), wherein said extruded film layer (a) is biaxially stretched and porous, wherein said extruded film layer (a) comprises high density polyethylene (HDPE) and particles of an incompatible material, wherein said extruded film layer (a) has a meshed network of HDPE fibers and striations of layers coplanar with the plane of the film, wherein said extruded film layer (a) is porous in a direction perpendicular to the plane of the film, wherein said extruded film layer (a) has a void content of at least about 20%, and wherein said coating layer (b) is a porous ink receiving layer with interconnecting voids.

### DETAILED DESCRIPTION

The porous HDPE layer may be described as having an open cell structure, wherein void spaces are continuous or interconnected so as to form pores which have an opening at an exposed surface of the layer.

Methods for making films with a surface layer with an open cell pore structure are described in U.S. application Ser. No. 09/079,807, filed May 15, 1998. According to this method a cavitating agent is used with a particular polymeric matrix material, which may be high density polyethylene (HDPE). When this material is stretched, separations which form voids are formed not only horizontally, i.e. within or parallel to the plane of the film, but also in the vertical dimension or perpendicular to the plane of the film.

As the term high density polyethylene (HDPE) is used herein, it is defined to mean an ethylene-containing polymer having a density of 0.940 or higher. (Density (d) is expressed as g/cm³.) It is noted that the tensile strength of HDPE increases when the density of HDPE increases. One particularly suitable HDPE is the resin sold as M6211 by Equistar. Another particularly suitable HDPE is the resin sold as HDZ128 by Exxon. Other HDPE resins include, for example, BDM 94-25 available from Fina Oil and Chemical Co. Dallas, Tex., and 19C and 19F available from Nova Corporation, Sarnia, Ontario, Canada.

An incompatible material, also referred to herein as a cavitating agent, is blended with HDPE to provide a voided layer. Such agents may be added to the HDPE prior to extrusion and are capable of generating voids (cavities) in the structure of the film during the film-making process. It is believed that small inhomogeneities introduced into the HDPE layer by the cavitating agent result in points of weakness in the polyethylene sheet. The biaxially orienting step then induces separations in the HDPE layer, causing cavitation in the processed film. As mentioned previously, the separations in the core layer vary in size and are formed not only horizontally, i.e., within or parallel to the plane of the film, but also in the vertical dimension or perpendicular to the plane of the film.

Inorganic cavitating agents, especially hydrophilic inorganic cavitating agents, may be used. Hydrophilic cavitating agents are particularly suited for substrates which are intended to be receptive to water based inks. A preferred cavitating agent is calcium carbonate (CaCO₃).

Organic cavitating agents may be used. When used, the organic cavitating agents may be extremely finely divided and resistant to melt at operating temperatures in order to produce the desired degree of inhomogeneity in the polymer sheet. Crosslinked polymeric cavitating agents tend to be particularly melt resistant. Cavitating agents can be included using methods known in the art, such as those described in U.S. Pat. Nos. 4,377,616 and 4,632,869, incorporated herein by reference.

The percentage of cavitating agent included in the HDPE layer, based on the entire weight of the layer, may be from 2 wt % to 40 wt %, for example, from 4 wt % to 24 wt %, e.g., from 7 wt % to 18 wt %, especially when CaCO₃ is used.

The blend of HDPE and cavitating agent may be passed through a flat sheet extruder die at a temperature ranging from about 230° C. to about 280° C. This layer may be coextruded with one or more core or backing layers to form a multi-layer film. The extruded layers may be cast onto a cooling drum, quenched and stretched to achieve biaxial orientation.

For example, extruded blends of HDPE and 5 to 10 wt % CaCO₃ may be cast onto a caster at a temperature between 160-180° F. (71-82° C.) depending upon the thickness of the sheet, i.e. the caster temperature may be higher for thicker sheets. In addition, each film may be stretched in the machine direction at a temperature about 245-250° F. (118-121° C.) and in the transverse direction at about 262° F. (128° C.).

Conventional casting apparatus may be used to prepare the present film. For example, cast extrusion may use a standard multi-roll stack system or a cast roll with an air cap (high velocity air applied to the outside of the sheet). A cast roll and water bath system may be used, although this type of system can affect film clarity, generally yielding a rougher and more opaque film.

Biaxial orientation of the present film tends to evenly distribute strength qualities of a film in the longitudinal or “machine direction” (MD) of the film and in the lateral or “transverse direction” (TD) of the film. Biaxial oriented films tend to be stiffer and stronger, and also exhibit much better resistance to flexing and folding forces.

Biaxial orientation can be conducted simultaneously in both directions, however, it is expensive to employ apparatus having the ability to do this. Therefore, most biaxial orientation processes use apparatus which stretches the films sequentially, first in one direction and then in the other, preferably in the MD first and then in the TD. A discussion of high biaxial orientation of polyethylene films is provided in U.S. Pat. No. 5,885,721. The present films may, for example, be stretched in the MD from about 5:1 to about 8:1 and in the TD from about 6:1 to about 15:1.

The present film may have more than one cavitated layer. For example, such a three layer film may have a cavitated HDPE surface layer, a cavitated HDPE core layer and a noncavitated (i.e. void free) thermoplastic skin layer.

When the cavitated surface layer is coextruded with one or more noncavitated backing layers, the film is more suited to biaxial orientation, especially in the transverse direction (TD). In particular, without the backing layer, the cavitated surface layer is prone to tearing when cavitated portions are secured by clamps, clips or hooks of a tenter frame and then stretched, especially under the conditions and processing rates used in commercial scale operations.

A non-cavitated backing layer may be separated from an open celled film layer by a simple peeling action. Such separation may take place without much resistance. Peeling the backing layer off of the cavitated surface layer may result in a film which is porous form one surface to the other in a direction perpendicular to the film.

Thinner backing layers, e.g., having a thickness of 0.05 mil or less, tend to be easier to peel off the back of a cavitated layer than thicker backing layers, e.g., having a thickness of greater than 0.05 mil.

The backing layer material may be polypropylene, HDPE or another polymer that can be coextruded with the rest of the film structure (i.e. the cavitated porous layers). For example, the backing layer material may be polypropylene homopolymer, EP copolymer, EPB terpolymer, HDPE, LDPE and other polymers.

Backing layer(s) may be made with various barrier polymers, and/or coated with various barrier polymers, to obtain a barrier layer. Examples of such barrier polymers include polyvinylidene chloride (PVDC) and polyvinyl alcohol (PVOH). The barrier layer may, optionally, be metallized or coated with other materials, such as silica.

Each of the cavitated layer(s) and backing layer(s) may optionally include various additives. Such additives include, but are not limited to, anti-blocks, anti-static agents, coefficient of friction (COF) modifiers, processing aids, colorants, clarifiers, and other additives known to those skilled in the art.

The present cavitated HDPE layers may each have a lofting value of at least 3, for example, about 5. Lofting value is defined herein as the thickness ratio achieved by dividing the thickness of the layer achieved with the cavitating agent by the thickness of the layer (with the same amount of polymer) achieved in the absence of the cavitating agent.

In view of the random matrix structure of the present cavitated HDPE layers, it is difficult to precisely measure the average pore diameter of these layers. However, average pore diameter may be estimated by observation of the film under a scanning type electron microscope. In general terms, these cavitated HDPE layers may have an average pore diameter of 0.1 to 10 microns, for example, from 0.1 to 2 microns.

These cavitated HDPE layers may have a void content (also referred to herein as porosity) of at least 20%, e.g., 20-85%, preferably at least 50%. Porosity is measured by dividing (T₁-T₂) by T₁ and multiplying this fraction by 100, wherein T₁ is the thickness of the cavitated layer and T₂ is the thickness of the layer in the absence of cavitation. T₂ may be calculated on the basis of the density of the HDPE.

Polyolefins may be treated to make them more receptive (or less unreceptive) to ink jet printing inks. Treating methods include casing, electronic treating and flame treating. Such treating methods may be used on one or both of the exposed surfaces of the present film.

A preferred treatment for the present films, especially for the exposed cavitated HDPE surface, is an atmospheric plasma treatment. Such atmospheric plasma treatments are described in U.S. Pat. No. 6,118,218 and in an article by S. A. Pirzada, A. Yializis, W. Decker and R. E. Ellwanger, entitled “Plasma Treatment of Polymer Films”, Society of Vacuum Coaters 42^{nd} Annual Technical Conference Proceedings, Chicago, 1999, pp. 301-306. By means of this atmospheric plasma treatment, it is possible to apply plasma to the cavitated polyolefin surface at a temperature less than the melting point of the polyolefin, e.g., less than 130° C. or even less than 100° C. Equipment for making such plasma treatments at or near atmospheric pressures is available from Sigma Technologies International, Inc., 10960 N. Stallard Place, Tucson, Ariz. An operating frequency of 40 kHz is recommended for plasma treatment of polymer surfaces.

An advantage of the atmospheric plasma treatment is that it can take place under conditions insufficient to generate enough heat to melt polymers or otherwise distort the structure of the film, especially the cavitated portions thereof. By way of contrast, U.S. Pat. No. 5,650,451 states that treatment of a biaxially oriented high molecular weight film at a temperature of 132 to 145° C. for one second to ten minutes can result in a loss of specific surface area of 20 m²/g or more.

When penetration of plasma into the open pores of the of an open celled film is desired, the operating frequency may be rather high. In particular, the frequency of the plasma generating electrode for pore penetration may be at least 1 MHz, for example, from 1 MHz to 20 MHz.

The plasma treating gas may include one or more of a variety of gasses including oxygen, nitrogen, air, carbon dioxide, methane and other reactive or inert gasses. For example, an oxygen containing gas, such as O₂, CO₂ or air, may be used alone or, optionally, in admixture with an inert gas, such as argon or helium.

The present atmospheric plasma treatment may optionally take place in the presence of a hydroxyl-donating material, such as methanol, in accordance with techniques described in U.S. Pat. No. 5,981,079.

The present microporous film may be ink jet printed with a wide variety of ink jet printing inks using a wide variety of ink jet printing processes. Both the ink jet printing inks and the ink jet printing processes are themselves conventional.

In certain ink jet printing processes, it may be desirable to laminate the present microporous film to a substrate of sufficient thickness and sufficient rigidity. Such substrates may be made from a variety of materials, including paper or plastic. Examples of plastic substrate materials include polyester, polycarbonate and polystyrene. The microporous film may be laminated to the optional substrate with a suitable adhesive, such as a hot melt or room temperature sealable adhesive or water based adhesive.

The microporous film may be coated with materials to make the surface receptive to ink jet printing. An optional first coating, which may be applied directly to the surface of the microporous film, is a primer coating. Examples of such primers include polyethyleneimine and epoxy resins.

As noted above, the porous image-receiving layer used in the invention contains interconnecting voids. These voids provide a pathway for an ink to penetrate appreciably into the substrate, thus allowing the substrate to contribute to the dry time. A non-porous image-receiving layer or a porous image-receiving layer that contains closed cells will not allow the substrate to contribute to the dry time.

Interconnecting voids in an image-receiving layer may be obtained by a variety of methods. For example, the layer may contain particles dispersed in a polymeric binder. The particles may be organic such as poly(methyl methacrylate), polystyrene, poly(butyl acrylate), etc. or inorganic such as silica, alumina, zirconia, titania, calcium carbonate or barium sulfate. In a preferred embodiment of the invention, the particles have a particle size of from about 5 nm to about 15 μm.

The polymeric binder which may be used in the image-recording layer of the invention, can be, for example, a hydrophilic polymer such as poly(vinyl alcohol), polyvinyl acetate, polyvinyl pyrrolidone, gelatin, poly(2-ethyl-2-oxazoline), poly(2-methyl-2-oxazoline), poly(acrylamide), chitosan, poly(ethylene oxide), methyl cellulose, ethyl cellulose, hydroxyethyl cellulose, hydroxypropyl cellulose, etc. Other binders can also be used such as hydrophobic materials such as poly(styrene-co-butadiene), a polyurethane latex, a polyester latex, poly(n-butyl acrylate), poly(n-butyl methacrylate), poly(2-ethylhexyl acrylate), a copolymer of n-butylacrylate and ethylacrylate, a copolymer of vinylacetate and n-butylacrylate, etc.

In another preferred embodiment of the invention, the volume ratio of the particles to the polymeric binder is from about 1:1 to about 15:1.

Other additives may also be included in the image-receiving layer such as pH-modifiers like nitric acid, cross-linkers, rheology modifiers, surfactants, UV-absorbers, biocides, lubricants, dyes, dye-fixing agents or mordants, optical brighteners etc.

An image-receiving layer may be applied to the substrate surface through conventional pre-metered or post-metered coating methods such as blade, air knife, rod, roll coating, etc. The choice of coating process would be determined from the economics of the operation and in turn, would determine the formulation specifications such as coating solids, coating viscosity, and coating speed.

The image-receiving layer thickness may range from about 1 to about 60 microns, preferably from about 5 to about 40 microns.

After coating, the ink jet recording element may be subject to calendering or supercalendering to enhance surface smoothness.

Ink jet printing inks are described in U.S. Pat. No. 6,020,398. Inks useful for ink jet recording processes generally comprise at least a mixture of a solvent and a colorant. The preferred solvent is de-ionized water, and the colorant is either a pigment or a dye.

### EXAMPLES

A three layer porous HDPE film was prepared. The film structure included a top porous skin layer A, and porous core layer B, and a bottom skin layer C.

The top porous skin layer A included 90.97 wt % HDPE (Exxon 7845.30) as the polymer matrix material, 9 wt % CaCO₃ and 0.03 wt % fluoropolymer as an internal lubricant. The CaCO₃ and fluoropolymer were both added in the form of a masterbatch with the polymer matrix material. More particularly, the top porous skin layer A included 79 wt % HDPE (Exxon 7845.30) as the polymer matrix material, 18 wt % CaCO₃ masterbatch containing 50 wt % CaCO₃, and 3 wt % of a masterbatch containing 1 wt % fluoropolymer as an internal lubricant.

The porous core layer B included 94 wt % HDPE (Exxon 7845.30) as the polymer matrix material, and 6 wt % CaCO₃. The CaCO₃ was both added in the form of a masterbatch with the polymer matrix material. More particularly, the porous core layer B included 88 wt % HDPE (Exxon 7845.30) as the polymer matrix material, and 12 wt % CaCO₃ masterbatch containing 50 wt % CaCO₃.

The bottom skin layer was a medium density polyethylene (MDPE) (Dowlex 2027A) with a minor amount of antiblock additives.

The total polymer gauge (without cavitation) is 1.4 mil. The cavitated film gauge after biaxial orientation was 4.5 mil. The total polymer gauge was measured after the cavitated film was pressed to a fully compacted state.

The polymer mixtures of the layers were extruded at around 250° C. into a base sheet, which is then stretched 5 times in the machine direction (MD) and 8 times in the transitional direction (TD).

The extruded film was plasma treated.

The inkjet receiver support sample was prepared in the following manner. The film of the invention (described above) and BICOR 70 MLT® film (made by Mobil Chemical Co.) were extrusion laminated to the paper stock described below. BICOR 70 MLT® is an oriented polypropylene film (18 microns thick). Reference is made to U.S. Pat. No. 5,244,861 where details for the production of this laminate are described.

These films may be laminated in a variety of ways (by extrusion, pressure, or other means) to a paper support. In the present context, they were extrusion laminated as described below with pigmented polyolefin on the frontside (image side) and clear polyolefin on the backside of the paper stock support. The film of the invention was laminated on the frontside and the BICOR 70 MLT® film was laminated on the backside. The pigmented polyolefin (12 g/m²) contained anatase titanium dioxide (12.5% by weight) and a benzoxazole optical brightener (0.05% by weight). The clear polyolefin was high density polyethylene (12 g/m²).

The paper stock was 137 microns thick and made from a 1:1 blend of Pontiac Maple 51® (a bleached maple hardwood kraft of 0.5 micron weighted average fiber length) available from Consolidated Pontiac, Inc., and Alpha Hardwood Sulfite® (a bleached red-alder hardwood sulfite on 0.69 micron average fiber length), available from Weyerhauser Paper Co. Ink Receiving Layer Compositions

Porous Composition 1

GASIL HP39® silica gel (Crosfield Limited): 6.5 parts

Gohsenol GH-23® poly(vinyl alcohol) (The Nippon Synthetic Chemical Industry Co., Ltd.): 3.5 parts

Water: 90 parts

Gohsenol GH-23® poly(vinyl alcohol) was slowly added with stirring to room temperature water over a 20 minute time period. The mixture was then heated to 90° C. and stirred until a clear solution was obtained. This solution was cooled to room temperature and the GASIL HP39® silica gel was added with stirring.

Porous Composition 2

GASIL HP39® silica gel: 9 parts

Gohsefimer Z-200® poly(vinyl alcohol) (The Nippon Synthetic Chemical Industry Co., Ltd.): 6 parts

Witcobond W-213® polyurethane (Witco Corporation): 1 part

N-(2-aminoethyl)-3-aminopropylmethyldimethoxysilane (United Chemicals Technologies, Inc.): 0.5 part

AlCl₃: 0.5 part

Surfactant 10G® nonylphenoxypolyglycidol (Olin Matheson Company): 0.5 part

Water: 82.5 parts

Gohsefimer Z-200® poly(vinyl alcohol) was slowly added with stirring to room temperature water over a 20 minute time period. The mixture was then heated to 90° C. and stirred until a clear solution was obtained. This solution was added to a mixture of room temperature water and GASIL HP39® silica gel. Witcobond W-213®, N-(2-aminoethyl)-3-aminopropylmethyldimethoxysilane, AlCl₃ and Surfactant 10G® were then added to this mixture and stirred.

Non-Porous Composition C-1

Gohsenol GH-23® poly(vinyl alcohol): 10 parts

Water: 90 parts

Gohsenol GH-23® poly(vinyl alcohol) was slowly added with stirring to room temperature water over a 20 minute time period. The mixture was then heated to 90° C. and stirred until a clear solution was obtained.

Non-Porous Composition C-2

Photographic grade bone gelatin: 10 parts

Water: 90 parts

Photographic grade bone gelatin was slowly added to water. This mixture was allowed to sit at room temperature for 30 minutes. The mixture was then heated to 40° C. and stirred until a clear solution was obtained.

Element 1 of the Invention

The ink permeable film support described above was coated at room temperature with Porous Composition 1 using a rod coater to give a dry thickness of 8 microns. The coating was allowed to air dry for 12 hours before printing.

Element 2 of the Invention

This element was prepared the same as Element 1 except that it used Porous Composition 2.

Control Element 1

This element was prepared the same as Element 1 except that it used Non-Porous Composition C-1.

Control Element 2

This element was prepared the same as Element 1 except that it used Non-Porous Composition C-2 and was coated at 40° C.

Control Element 3

This element was tested using the Ink Permeable Film Support of the Invention alone without any image-receiving composition.

Printing

Images were printed using an Epson Stylus Color 900® printer for dye-based inks using Color Ink Cartridge T005 011® and Black Ink Cartridge T003 011®. The images comprised a series of cyan, magenta, yellow, black, green, red and blue stripes, each stripe being in the form of a rectangle 1.1 cm in width and 18 cm in length.

Dry Time

Immediately after ejection from the printer, the printed image was set on a rubber mat (image side up) and a piece of bond paper was placed over the printed image. A steel cylinder (33 cm long, 5 cm in diameter and weighing 1747 g) was then rolled over the top of the bond paper, after which the bond paper was separated from the printed image. The samples were rated for dry time based on the length of dye transfer and the stripe densities on the bond paper. This is an estimate of the time needed for the printed image to dry. The dry time was rated as 1 when there was no transfer of the inks to the bond paper. The dry time was rated as 5 when there was full transfer of the color stripes to the bond paper and the density of the transferred stripes was high. Intermediate transfer lengths and densities were rated in-between 1 and 5. Only the cyan, magenta and yellow stripes were measured in the dry time evaluation.

Image Density

The cyan density of the cyan stripe on the printed image was measured using an X-Rite Densitometer Model 820®. Densities of 1.0 or greater are considered acceptable for most imaging applications. The following results were obtained:

TABLE

| Element | Coating | Support | Dry Time | Cyan Density |
|---|---|---|---|---|
| 1 | Porous | Ink Permeable | 1 | 1.49 |
| | Composition 1 | Film Substrate | | |
| 2 | Porous | Ink Permeable | 1 | 1.68 |
| | Composition 2 | Film Substrate | | |
| Control | Non-Porous | Ink Permeable | 2.5 | 2.15 |
| 1 | Composition C- | Film Substrate | | |
| | 1 | | | |
| Control | Non-Porous | Ink Permeable | 3 | 2.26 |
| 2 | Composition C- | Film Substrate | | |
| | 2 | | | |
| Control | None | Ink Permeable | 1 | 0.71 |
| 3 | | Film Substrate | | |

The above results show that receiving elements employed in the invention gave both good dry times and good printed densities, as compared to the control elements. While Control Elements 1 and 2 show that good printed densities can be obtained, they had poor dry time results. While Control 3 had a good dry time, it had a low printed density.

What is claimed:

1. A film comprising an ink jet printed microporous material comprising (a) an extruded film layer and (b) a coating layer coated on a surface of said extruded film layer (a), wherein said extruded film layer (a) is biaxially stretched and porous, wherein said extruded film layer (a) comprises high density polyethylene (HDPE) and particles of an incompatible material, wherein said extruded film layer (a) has a meshed network of HDPE fibers and striations of layers coplanar with the plane of the film, wherein said extruded film layer (a) is porous in a direction perpendicular to the plane of the film, wherein said extruded film layer (a) has a void content of at least about 20%, and wherein said coating layer (b) is a porous ink receiving layer with interconnecting voids.

2. A film according to claim 1, wherein said incompatible material is calcium carbonate.

3. A film according to claim 1 which is laminated to a paper or plastic substrate.

4. A film according to claim 1 which is porous from one surface to the other in a direction perpendicular to the plane of the film.

5. A film according to claim 1, wherein said extruded film layer (a) is treated with plasma at a temperature below the melting point of said HDPE.

6. A film according to claim 1, wherein said extruded film layer (a) is coextruded with two other film layers, so as to form a three-layer film structure comprising said extruded layer (a), a core layer (c) and a skin layer (d), said extruded layer (a) and said skin layer (d) being on opposite sides of said core layer (c), wherein said core layer comprises high density polyethylene (HDPE) and particles of an incompatible material, wherein said core layer (c) has a meshed network of HDPE fibers and striations of layers coplanar with the plane of the film, wherein said core layer (c) is porous in a direction perpendicular to the plane of the film and wherein said core layer (c) has a void content of at least about 20%.

7. A film according to claim 6, wherein said skin layer (d) is a nonporous layer.

8. A film according to claim 1, wherein said coating layer (b) comprises particles of silica and alumina and a binder of polyvinyl alcohol or gelatin.

9. A method for producing an ink jet printed microporous material, said method comprising applying ink jet printing ink from an ink jet printer upon at least one surface of a coated microporous material, wherein said coated microporous material comprises (a) an extruded film layer and (b) a coating layer coated on a surface of said extruded film layer (a), wherein said extruded film layer (a) is biaxially stretched and porous, wherein said extruded film layer (a) comprises high density polyethylene (HDPE) and particles of an incompatible material, wherein said extruded film layer (a) has a meshed network of HDPE fibers and striations of layers coplanar with the plane of the film, wherein said extruded film layer (a) is porous in a direction perpendicular to the plane of the film, wherein said extruded film layer (a) has a void content of at least about 20%, and wherein said coating layer (b) is a porous ink receiving layer with interconnecting voids.

10. A method according to claim 9, wherein said ink jet printing ink is a water based ink jet printing ink.
